(19) United States
(12) Patent Application Publication
(10) Pub. No.: US 2014/0033597 A1
(43) Pub. Date: Feb. 6, 2014

(54) CARBON DIOXIDE GENERATOR FOR BED BUG TRAPS AND OTHER USES

(71) Applicant: Bug Elimination and Prevention Corporation, Waterloo (CA)

(72) Inventors: Kailash C. Vasudeva, Waterloo (CA); Satnam Singh, Kitchener (CA); Jose A. da C. Medeiros, Cambridge (CA)

(73) Assignee: Bug Elimination and Prevention Corporation, Waterloo (CA)

(21) Appl. No.: 13/956,612

(22) Filed: Aug. 1, 2013

Related U.S. Application Data
(60) Provisional application No. 61/678,588, filed on Aug. 1, 2012.
(60) Provisional application No. 61/716,054, filed on Oct. 19, 2012.

(51) Int. Cl. A01M 1/02; A01M 1/10

(52) U.S. Cl. CPC A01M 1/023; A01M 1/10
USPC 43/2; 43/132.1; 43/107

(57) ABSTRACT

A carbon dioxide generator includes: a storage chamber at the bottom, which is charged with solid that can produce carbon dioxide by adding fluid; a gas chamber above the storage chamber; a fluid inlet and a carbon dioxide outlet on the top of the gas chamber. The storage chamber and the fluid chamber are connected by at least two holes which permit fluid to enter the storage chamber and carbon dioxide to escape from the storage to the fluid chamber. A method of using this generator to produce carbon dioxide includes adding fluid to the generator. It can supply an even and targeted carbon dioxide output, making it useful for attracting bed bugs or mosquitos to bed bug or mosquito traps for detection and/or elimination.

### REFERENCE TO RELATED APPLICATION

This is a formal application based on and claiming the benefit of U.S. provisional applications of Ser. No. 61/678,588, filed Aug. 1, 2012 and Ser. No. 61/716,054, filed Oct. 19, 2012.

### BACKGROUND OF THE INVENTION

This invention relates to a carbon dioxide generator and carbon dioxide generating method for bed bug detecting and trapping, and potentially for other uses where a controlled release of carbon dioxide for period of time is desired.

It is well known that carbon dioxide is an attractant for bed bugs, especially but not necessarily when used in combination with warmth and chemical attractants.

There is therefore a need for devices which can generate carbon dioxide in suitable volumes over a suitable time period, either in combination with a bed bug or mosquito trap, i.e. attached or attachable thereto, or placed in the vicinity of the bed bug or mosquito trap.

Various carbon dioxide supplying devices and processes are known in the prior art. For example, the supply can be provided by gas dosing systems from gas cartridges which are pressure charged with carbon dioxide. However, this method has the drawback that with decreasing gas pressure in the cartridge, the amount of carbon dioxide which is supplied per unit of time continuously decreases. In addition, a carbon dioxide supply system using gas cartridges requires a large amount of space and is aesthetically unsatisfactory.

Another known method is in-situ generation of carbon dioxide from a carbonate due to the influence of a mineral acid, which is usually hydrochloric acid in a Kipp's apparatus. However, it also has the same spatial and aesthetic inadequacies as gas cartridges.

In addition, it is known to use an effervescent tablet of sodium hydrogen carbonate and citric acid so that carbon dioxide is released in doses by the slow addition of water. But there is no generator that is ready for use and it is hard to control the reaction velocity.

In US2006/0016120A1, a device that generates carbon dioxide through a chemical reaction is provided. In this device, a valve is needed to control the reaction and the device has to be controlled by a human being.

In attracting bed bugs to a trap, whether for detection or elimination or both, there is a need for continuous, controlled and environmentally-friendly carbon dioxide generator. Satisfactory devices or methods for generating carbon dioxide for use in insect and/or bed bugs traps that are inexpensive, non-electrical, environmentally friendly, and sufficiently controllable have not been available to date.

It is well known that an insect trap baited with carbon dioxide and a chemical lure works well, but there is no device that can produce carbon dioxide and supply the carbon dioxide and send it to the trap with a chemical lure in a way that can enhance the attracting effects.

In view of the preceding, it would therefore be advantageous to develop a device and a method that can generate carbon dioxide in situ for use in insect and/or bed bug traps. It would also be advantageous to further include a chemical lure in the device in a way that the chemical lure and carbon dioxide can be premixed and supplied to the trap at the same time.

### SUMMARY OF THE INVENTION

It is therefore an object of the invention to provide a carbon dioxide generator for use in conjunction with bed bug traps and potentially other uses where a controlled release of carbon dioxide is desired.

In one exemplary example, the carbon dioxide generator includes: at least one storage chamber at the bottom, charged with solid that can produce carbon dioxide; a fluid-fillable fluid chamber above the storage chamber; a fluid inlet and a carbon dioxide outlet on the top of the liquid chamber; and one or more fluid entry holes between the fluid chamber and storage chamber for fluid to reach the solid to produce carbon dioxide.

The generator could further include a gas chamber above the fluid chamber, with the fluid inlet and the carbon dioxide outlet on the top of the gas chamber.

Preferably, a foam or sponge layer separates the fluid chamber and the storage chamber so that fluid trickles in slowly.

Preferably, additional attractants such as L-lactic acid, octenol, organic acid and so on can also be absorbed in the sponge to enhance or to attract specific insects. When the generator is used for a bed bug or mosquito trap, these additional attractants can be carried from the generator to the trap by carbon dioxide, to enhance the attracting effects of the carbon dioxide.

Preferably, the storage chamber is divided into two or more cells. In a preferred embodiment, the chamber has three such cells. Each cell may have a fluid entry hole of a different size, or at least one cell may have a fluid entry hole of a different size, so that fluid enters the cells at different rates, resulting in carbon dioxide production at different rates. This provides an extra initial burst of carbon dioxide on activation, i.e. while all chambers are active and before one or more chambers (i.e. the ones with larger fluid holes) are expended.

The storage chamber, the fluid chamber and the gas chamber can be mounted together by any conventional means, such as heat melting, glue, ultrasonic welding, threading, or a combination thereof

The solid that can produce carbon dioxide by adding fluid includes a compound, such as a solid water soluble acid, a solid hydrogen carbonate salt or a solid carbonate salt. It can also be a composition comprising, for example, a solid water soluble acid and a solid hydrogen carbonate salt or a solid carbonate salt. When the solid is a solid hydrogen carbonate salt or a solid carbonate salt, fluid or water soluble acid solution can be added to produce carbon dioxide. When the solid is a solid water soluble acid, hydrogen carbonate salt or carbonate salt solution can be added to produce carbon dioxide. When the solid is a composition comprising a solid water soluble acid and a solid hydrogen carbonate salt or a solid carbonate salt, water can be added to produce carbon dioxide.

Persons skilled in this area can choose any suitable solid for the storage chamber and accordingly choose a suitable fluid to be added to the fluid chamber to produce carbon dioxide.

In this application, fluid could be any liquid, such as water or an aqueous solution of a compound or composition. The fluid can be preloaded in the form of a fluid bag or capsule that can be pierced by closing of a lid or other means, to thereby activate the carbon dioxide generator. Alternatively, the fluid can be preloaded in a bottle. To generate carbon dioxide, the fluid can be added to active the generator and immediately produce carbon dioxide.

In another example, the storage chamber has only one cell and the cell is covered by a sponge. Such a generator can supply carbon dioxide at a sufficient rate for potentially six hours or more.

Preferably, the storage chamber is mounted to the fluid chamber by detachable means. It can be any normal means used in the art, for example a screw-on connector, a twist lock arrangement, and so on. In this way, the storage chamber can be refilled with a solid that can produce carbon dioxide; or the storage chamber can be replaced by a substituted new storage chamber when the solid in the storage chamber is consumed. The substituted storage chamber is filled with the solid and sealed by normal means, such as plastic lid, or a plastic/aluminium film.

Preferably, the storage chamber has one or more discharge outlets to drain solution from the chamber. The solution in the chamber contains anions from the ionization of water soluble acid and ions from the ionizing of the hydrogen carbonate salt, which prevents the water soluble acid and hydrogen carbonate salt from ionizing, and therefore results in a lower carbon dioxide production rate. By draining the solution from the storage chamber, fluid can be added to the storage chamber and the carbon dioxide production velocity can be increased.

The method of generating carbon dioxide with the carbon dioxide generator includes adding fluid through the fluid inlet to the fluid chamber. Fluid trickles through the optional sponge and through the fluid holes on the top of the cells, the material that can produce carbon dioxide by adding fluid in the cells is contacted by fluid, causing chemical reaction to generate carbon dioxide; and the carbon dioxide generated from the cell is released to the gas chamber and released therefrom through a carbon dioxide outlet.

Another object of the invention is to provide a method for producing the carbon dioxide generator which includes: charging a storage chamber with solid that can produce carbon dioxide by adding fluid; and mounting the storage chamber, the gas chamber and the fluid chamber together.

Another object of the invention is to provide the usage of the generator in conjunction with insect traps, and potentially other uses where a controlled release of carbon dioxide is desired. The insects include crawling insects or flying insects that are attracted to carbon dioxide.

In one example, a chemical lure is carried on the sponge in the generator and is carried out by carbon dioxide, so that the mixture of carbon dioxide and a chemical lure can work together to enhance the attracting effects. Preferably, the chemical lure comprises one or more volatile organic compounds that can easily be carried out by carbon dioxide gas stream.

In another example, the carbon dioxide generator is used for supplying carbon dioxide for attracting bed bugs to a bed bug trap. In that example, the outlet of the generator is connected to the bed bug trap. The outlet of the generator is configured to directly introduce carbon dioxide to the trap.

The following advantageous effects are achieved by this carbon dioxide generator, its production method and carbon dioxide generating method: the release of carbon dioxide is carried out in a small space and in-situ; the carbon dioxide release rate can be controlled; and in preferred embodiments where at least parts of the device are transparent, the release of carbon dioxide is visible as bubbles through the water, to reassure the user that the device is working Carbon dioxide gas generated by this safe and environmentally friendly generator can be used in existing devices or in new devices, such as insect traps.

One unexpected effect is that when a chemical lure is carried on a sponge, when carbon dioxide passes the sponge and carries the chemical lure to the trap directly, the carbon dioxide with the chemical lure is more attractive to bed bugs than in traps where carbon dioxide and a chemical lure are supplied separately.

Further details of the invention will be described or will become apparent in the course of the following detailed description and drawings of specific embodiments of the invention, as examples.

### BRIEF DESCRIPTION OF THE DRAWINGS

Embodiments of the invention will now be described, by way of example only, with reference to the attached drawings, in which:

FIG. 1 is a perspective view of a first example of the invention;

FIG. 2 is a cross-sectional elevation view of the device of FIG. 1;

FIG. 3 is an exploded view of the device of FIG. 1;

FIG. 4 is an exploded perspective view of an alternative embodiment of the invention (in which the fluid chamber and gas chamber are one piece);

FIG. 5 is a cross-sectional elevation view of an alternative embodiment of the invention;

FIG. 6 is a cross-sectional perspective view corresponding to FIG. 5;

FIG. 7 is an exploded perspective view corresponding to FIG. 5; and

FIG. 8 is a perspective view of a carbon dioxide generator combined with a trap.

### DETAILED DESCRIPTION OF THE INVENTION

### Carbon Dioxide Generator

### EXAMPLE 1

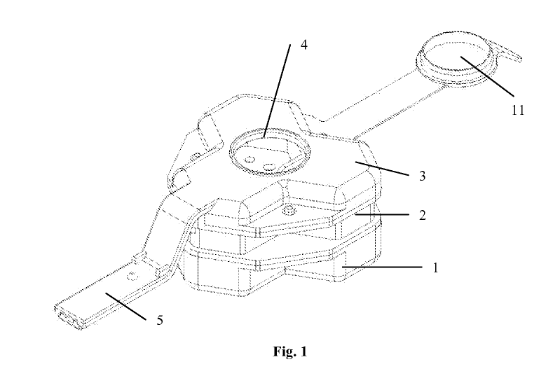

A first example of the invention is illustrated in FIGS. 1, 2 and 3. The carbon dioxide generator includes: a storage chamber 1 at the bottom, a fluid chamber 2 above the storage chamber 1, and a gas chamber 3 above the fluid chamber 2; and a fluid inlet 4 and a carbon dioxide outlet 5 on the top of the gas chamber 3. The storage chamber 1 is divided into three cells 6, each cell 6 being charged with solid that can produce carbon dioxide. A piece of sponge 10 covers the solid in each cell. Each cell 6 and the fluid chamber 2 are connected by two holes 9. A hinged lid 11 that fits the fluid inlet 4 is attached to the liquid chamber 2.

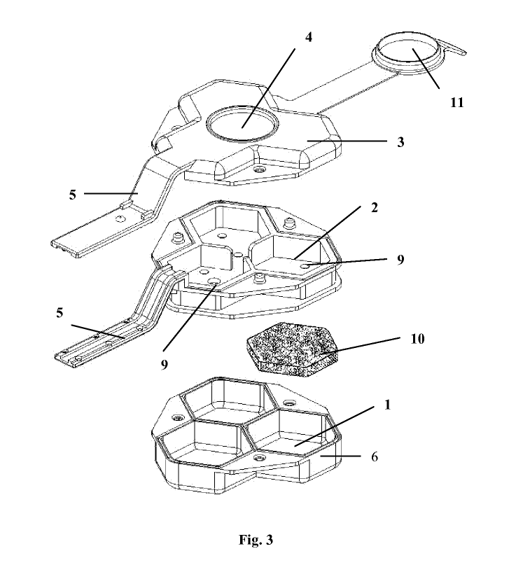

The storage chamber 1 has a sidewall and a bottom wall. The storage chamber is divided to three cells by clapboard, shown in FIG. 3, as an example. However, the number of cells can be adjusted according to the size of the storage chamber 1 and the volume of carbon dioxide desired to be produced. It is preferable to have two or more cells so that an initial burst of carbon dioxide can be provided by having one or more cells producing carbon dioxide at different rates.

As shown in FIG. 3, the liquid chamber 2 has a sidewall and a bottom wall. On the bottom wall, there are one or more holes 9 for liquid in the liquid chamber 2 to pass down into each cell of the storage chamber 1. Above each cell, there are one or more holes 9 for fluid to pass down from the fluid chamber 2 to each cell 6. The size and number of holes 9 can be varied as desired, according to the desired carbon dioxide production rate vs. time profile.

The solid that can produce carbon dioxide in this example is a hydrogen carbonate salt, such as sodium bicarbonate (NaHCO₃). It is in the form of tablets, such as 0.5 g each. In other examples, the solid is baking soda (NaHCO₃) and citric acid. In another example, ENO (trademark) product is used, which is 39.0 wt % soda (NaHCO₃), 51.22 wt % citric acid and 9.77 wt % ENO. (ENO is a trademark of GlaxosmithKline Consumer Healthcare Inc., for an antacid product.)

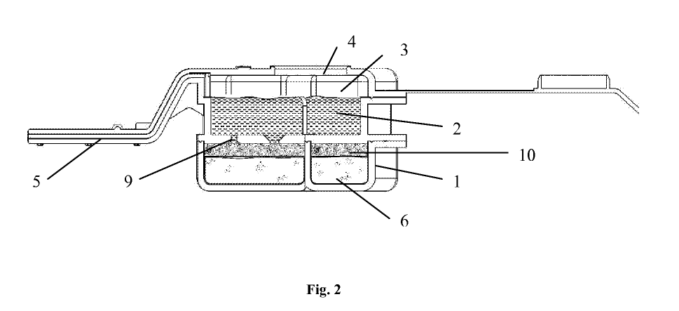

As shown in FIGS. 2 and 3, a piece of sponge 10 formed to the same shape as the cell 6 is optionally used in each cell to cover the solid. The sponge can slow the velocity of the fluid going into the storage chamber from the liquid chamber. The thickness and porosity of the sponge 10 can be adjusted according to the rate of fluid desired. Typical thicknesses may be in the range of 0.5 mm to 2 cm, or preferably from 0.5 mm to 2 mm. The density of the sponge 10 may be in the range of 5-40 kg/m³, such as 25 kg/m³ for example. The use of sponges can also help to hold the solid in place and to protect it from moisture. Preferably, sponge is used in at least two cells, and different cells have different sponge thicknesses and porosity.

When the generator is used for a bed bug trap or other insect trap, a chemical lure can also be absorbed in the sponge to enhance attraction of insects. When produced carbon dioxide passes through the sponge, it carries the chemical lure in the sponge to the outlet and to the trap.

As an example, the chemical lure comprises: 1 part of nonanal, 1 part of 1-octen-3-ol, 1 part of L-lactic acid, and 1 part of spearmint oil, and the total quantity is 50 ul to 400 ul. In another example, the lure comprises: 1 part of nonanal, 1 part of 1-octen-3-ol, and 1 part of L-lactic acid, and the total quantity is 50 ul-400 ul. The chemical lure can be any kind of chemical lure used for insects. Preferably, the chemical lure comprises one or more volatile organic compounds.

Tests results show that the chemical lure carried out from the sponge by carbon dioxide works better than if the chemical lure is placed directly in the trap, possibly because the chemical lure and carbon dioxide are well mixed in this configuration, to perhaps better mimic a human or other target for the insects. The sponge thus has this additional function.

However, it should be understood that the generator can also work without a sponge 10, for example by using small holes to provide slow fluid entry, and/or by using compositions which dissolve very slowly to produce carbon dioxide. The sponge could also be one piece shaped to the same shape of the top of the storage chamber to cover the whole storage chamber.

As shown in FIGS. 1-3, the storage chamber 1, the fluid chamber 2 and the gas chamber 3 are mounted together by glue, but obviously they can be mounted together by any other conventional means, such as heat melting, ultrasonic welding, etc.

As shown in FIGS. 1-3, the carbon dioxide outlet 5 is a long U-shaped channel, which is formed by joining and sealing two halves of U-shaped channels respectively on the fluid chamber 2 and the gas chamber 3. The outlet 5 is a long channel, facilitating connection to devices such as bed bug or mosquito traps, to introduce carbon dioxide directly to the devices (as shown in FIG. 8).

With the sponge 10 and small holes 9, fluid in fluid chamber 2 continuously drips into the storage chamber 1 and continuous carbon dioxide is produced. The process does not require human monitoring or control, and can last for potentially several hours (nominally but not necessarily two hours).

To generate carbon dioxide, fluid is added through the fluid inlet 4 to the fluid chamber 2 and the fluid inlet 4 is closed by the lid 11. By gravity, fluid seeps into the storage chamber through the holes 9 on the top of the cells 6 and the sponge 10, to contact the solid in the cell 6. Due to the sizes of holes 9 and the sponge 10, fluid chamber 2 will release fluid at controlled amounts into each of the cells in the storage chamber 1. The resulting reaction generates carbon dioxide at a controlled amount during a period. Through buoyancy, the carbon dioxide escapes from the storage chamber 1 in the form of bubbles through holes on the bottom of the fluid chamber 2, dispersing into gas in the gas chamber 3. To assist the user, this activity is visual, as the gas and fluid chambers preferably are transparent. Through the increased pressure due to increased volume in the gas chamber and minor forces of gravity, the carbon dioxide is forced through carbon dioxide outlet 5. By seeing these bubbles, the user would know if carbon dioxide was being produced, even though carbon dioxide gas has no color or smell. This feature therefore provides the user with confidence that the device is working to produce carbon dioxide.

In one example, the solid in the storage chamber 1 is 12 pieces of sodium bicarbonate tablets and each tablet contains 0.5 g sodium bicarbonate (baking soda). The solution added to the fluid chamber is 4.9 g citric acid with 9 ml water. The subsequent release of carbon dioxide lasts for nominally 2 hours at an average release rate of carbon dioxide of at least 10 ml/min. The quantity of tablets and citric acid added to the generator could be adjusted according to the desired volume and rate of carbon dioxide. Since baking soda and citric acid are domestic products, they are safe for use anywhere.

Carbon dioxide generator is essentially as described previously. The use of the gas chamber can decrease the liquid carried in the produced carbon dioxide. However, the generator can work without a gas chamber, as shown below in one alternative embodiment of the invention, where the gas chamber and water chamber are essentially one chamber.

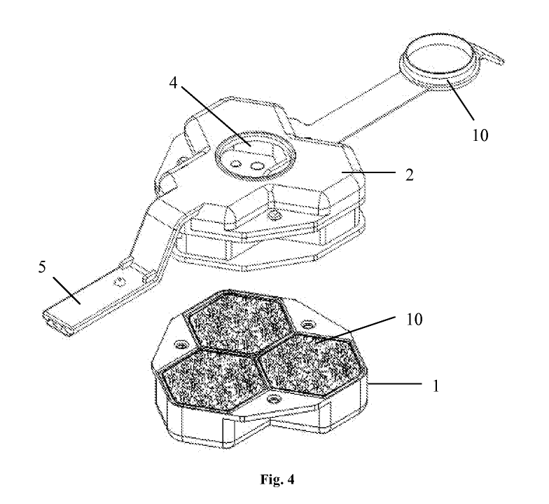

An alternative embodiment for this example of the invention is illustrated in FIG. 4. The carbon dioxide generator includes: a storage chamber 1 at the bottom and a fluid chamber 2 at the top of the storage chamber 1. There is a fluid inlet 4 and a carbon dioxide outlet 5 on the top of the fluid chamber 2. The storage chamber 1 is divided to three cells 6, each cell 6 being charged with a suitable solid as previously described. The cells may be covered with sponge as previously described. Each cell 6 and the fluid chamber 2 are connected by holes 9.

### Carbon Dioxide Generator

### EXAMPLE 2

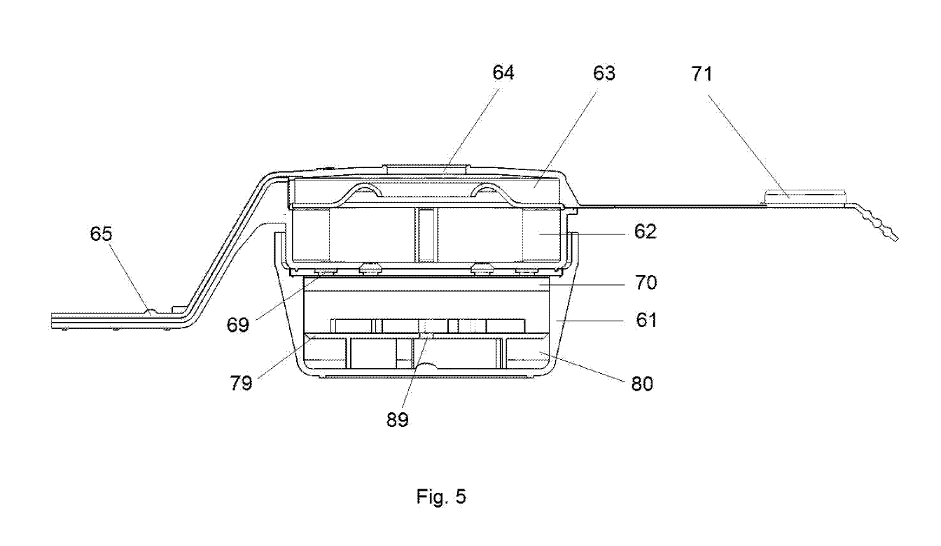

A second main example of the invention is illustrated in FIGS. 5-7. The carbon dioxide generator includes: a storage chamber 61 at the bottom; a fluid chamber 62 above the storage chamber 61; a gas chamber 63 above the fluid chamber 62; and a fluid inlet 64 and a carbon dioxide outlet 65 on the top of the gas chamber 63. The storage chamber 61 and the fluid chamber 62 are connected by one or more holes 69 at the bottom of the fluid chamber 62.

Preferably, a hinged lid 71 that fits the fluid inlet 64 is attached to the liquid chamber 62.

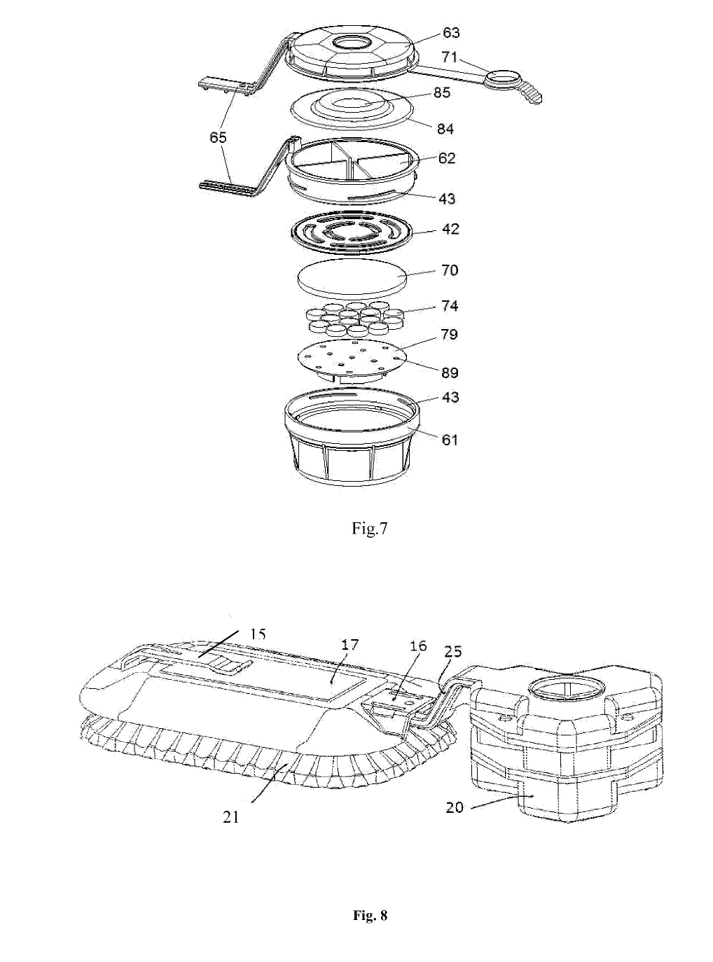

As shown in FIG. 7, the inner wall of the upper edge of the cylindrical wall of the storage chamber 61 and the outer wall of the lower edge of the cylinder wall of the fluid chamber 62 have complementary threads 43. Therefore, the storage chamber 61 can be screwed on or off from the fluid chamber 62, so that the storage chamber 61 is detachably fixed to the fluid chamber 62.

The detachable connecting means between the storage chamber 61 and the fluid chamber 62 could be any conventional means, including a twist lock for example.

As shown FIG. 7, the gas chamber 63 includes a top part and a bottom 84 with middle hole 85 that liquid can pass through to the liquid chamber 62, and produced carbon dioxide can pass from the liquid chamber to the gas chamber. The gas chamber 63 and the fluid chamber 62 can be glued together or they can be made of one piece.

The presence of a gas chamber can decrease the fluid carried in the produced carbon dioxide. But it is not necessary, i.e. the gas chamber can be omitted.

Therefore, the generator can be formed by an upper piece, which can be reused, and bottom storage chamber piece, which can be refilled or replaced.

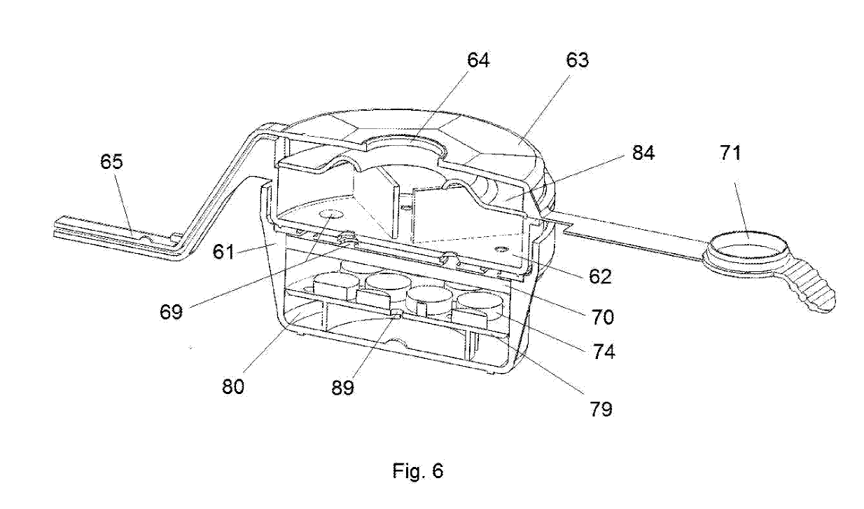

As shown in FIGS. 6 and 7, the storage chamber 61 has a cylindrical shape formed by a sidewall and a bottom. The storage chamber 61 is charged with a solid 74 (such as sodium bicarbonate tablets). A piece of sponge 70 covers the top of the chamber 61. Optionally, to keep the sponge 70 and the solid in place, a cover 42 is on the top of the storage chamber 61. From the top to the bottom, the storage chamber 61 thus includes cover 42, sponge 70, and tablet 74.

When the solid in the storage chamber 61 is all consumed, the storage chamber 61 can be screwed off the fluid chamber 62. The storage chamber 61 can be refilled with solid that can produce carbon dioxide, or the storage chamber 61 can be replaced by a substituted storage chamber. The substitute storage chamber is filled with solid.

As shown in FIGS. 6-7, a piece of sponge 70 formed to the same shape of the storage chamber 61 is used to cover the solid. The sponge can slow the rate of fluid going into the storage chamber. The thickness and porosity of the sponge 70 can be adjusted according to the rate of fluid desired. Typical thicknesses may be in the range of 0.5 mm to 2 cm, or preferably from 0.5 mm to 2 mm. The use of sponges can also help to hold the solid in place for storage and to protect it from moisture in the air.

When the generator is used for a bed bug trap or other insect trap, additional chemical lure could also be absorbed in the sponge to enhance attraction of insects. When produced carbon dioxide passes through the sponge, it can carry the chemical lure from the sponge to the outlet and to the trap.

As an example, the chemical lure may comprise: 1 part of nonanal, 1 part of 1-octen-3-ol, 1 part of L-lactic acid, and 1 part of spearmint oil, and the total quantity is 50 ul to 400 ul. In another example, the lure may comprise: 1 part of nonanal, 1 part of 1-octen-3-ol, and 1 part of L-lactic acid, and the total quantity is 50 ul-400 ul. The chemical lure can be any kind of chemical lure used for different kinds of insects.

Test results show that the chemical lure carried out from the sponge works better than if the lure was directly used in the trap. That is, the combination of carbon dioxide with a chemical lure can greatly enhance the trap catch, as stated above previously.

As shown in FIG. 7, the storage chamber could also include a separate plate 79 at the middle of the storage chamber 61 to form a drained space 80 at the bottom of the storage chamber 61. There are one or more discharge outlets 89 on the separate plate 79. The solid can be kept on the separate plate 79. The outlet 89 can drain solution from the storage chamber 61 to the drained space 80. The solution in the chamber 61 contains anions from the ionizing of water soluble acid and ions from the ionizing of hydrogen carbonate salt, which prevent the water soluble acid and hydrogen, carbonate salt from ionizing, resulting in a lower carbon dioxide production rate. By draining the solution from the tablets to the drained space 80, fresh fluid can be added to the tablet and the carbon dioxide production rate can be increased.

Optionally, the separate plate 79 has some curved ribs at the bottom of the plate to support the plate at some height above the storage chamber.

To generate carbon dioxide, fluid (in this example, citric acid solution) is added through the fluid inlet 64 to the gas chamber and then to the fluid chamber 62. By gravity, fluid seeps into the storage chamber 61 through the holes 69 onto the sponge 10 and then contacts the tablets 74 in the chamber 61. The resulting reaction generates carbon dioxide, which goes up through the sponge, then is released through holes 69 and gets through the fluid chamber 62 and then the gas chamber 63 and is released through the carbon dioxide outlet 65. Bubbles of carbon dioxide can be seen in the fluid chamber 62 by making the fluid chamber transparent. Without seeing these bubbles, the user would not know if carbon dioxide was being produced, since carbon dioxide gas has no color or smell. This feature therefore provides the user with confidence that the device is working to produce carbon dioxide.

The solution at the bottom of the storage chamber 61 is drained through the discharge outlet 89 to the drained space 80. Therefore, unreacted fluid can go through the holes to the drained space and react with the tablets in the chamber and produce more carbon dioxide.

In this example, the solid in the storage chamber 61 is thirty-six pieces of sodium bicarbonate tablets and each tablet contains 0.5 g sodium bicarbonate. The solution added to the fluid chamber is 14.7 g citric acid with 20-30 ml water. The subsequent release of carbon dioxide lasts for nominally 6 hours with an average release rate of carbon dioxide of at least 10 ml/min. The quantity of tablets and citric acid added to the generator could be adjusted according to the desired volume and rate of carbon dioxide.

### Method of Producing the Carbon Dioxide Generator

A method for producing a carbon dioxide generator includes charging a storage chamber with solid that can produce carbon dioxide, and mounting the storage chamber, the gas chamber and the fluid chamber together.

The method of producing a carbon dioxide generator may further include the step of separating the storage chamber 1 into two or more cells. The number of cells can be adjusted according to the size of the storage chamber and the volume of carbon dioxide desired to be produced. It is preferable to have two or more cells so that an initial burst of carbon dioxide can be provided by having one or more cells producing carbon dioxide at different rates.

The method of producing a carbon dioxide generator may further include the step of putting a sponge or sponges on the top of the solid before assembly. It may further include the step of absorbing chemical lure on the sponge.

The solid that can produce carbon dioxide could be a compound of a solid water soluble acid, a solid hydrogen carbonate salt or a solid carbonate salt. It could also be a composition comprising, for example, a solid water soluble acid and a solid hydrogen carbonate salt or a solid carbonate salt.

Preferably, if the solid is a composition, it is premixed and it is discharged in the one or more cells of the storage chamber. Or the composition can be unmixed and different components can be stored in different cells of the storage chamber, or different components can be stored in different layers of every cell of the storage chamber.

The method of producing a carbon dioxide generator may further include the step of drilling or otherwise providing holes at the bottom of the fluid chamber. The number and the size of the holes can be adjusted according to the desired reaction velocity and carbon dioxide release rate.

The method of producing a carbon dioxide generator may further include providing a separate plate with discharge outlets to form a drained space at the bottom of the storage chamber. By draining the solution from the storage chamber to the drained space, fresh fluid can be added to the storage chamber and the carbon dioxide production rate can be increased.

The storage chamber, the fluid chamber and the gas chamber can be made of any normal material that can be used for acid and base reactions, such as plastic, ceramic or inorganic material. Preferably, the generator is made of plastic since it is inexpensive.

The storage chamber, gas chamber and fluid chamber can be mounted together permanently or detachably by any conventional means, such as heat melting, glue, ultrasonic welding, screw-on, twist lock, threading, or a combination thereof

Alternatively, the gas chamber and the fluid chamber can be made in one piece.

The cap or lid of the fluid inlet is preferably built as integral part of a shell with flexible connectivity. The storage chamber is preferably built by snap fitting two slideable shell cups for collapsibility/expandability. As mentioned before, the storage chamber can be replaced. It may be sealed to keep moisture out for prolonged shelf life. The sealing can be achieved through foil/film as the chamber, or vacuum sealing in a polymer bag, such as is common for printer ink cartridges, or by other means.

The method of producing a carbon dioxide generator may further include the step of controlling humidity, preferably below 30%, during charging of the composition and assembly step.

The method of producing a carbon dioxide generator may further include making the fluid chamber 2 and the gas chamber 3 with two U-shaped halves, further joining and sealing the two halves of U-shaped channels to form the carbon dioxide outlet 5. This forms a long channel, which can transfer produced carbon dioxide directly to bed bug traps or detection tools.

### Usage of Carbon Dioxide Generator

The carbon dioxide generator can be used for supplying carbon dioxide for bed bug detecting and killing. For example, the outlet of the generator can be connected to bed bug traps to supply carbon dioxide as an attractant of bed bugs for the trap; or the generator can be just put sufficiently near the bed bug trap or any capture tools. The device can also be incorporated in bed bug traps to provide an attractant. The carbon dioxide can also be used for traps for other insects, like mosquitoes or any other insects attracted by carbon dioxide.

FIG. 8 shows the carbon dioxide generator used with a bed bug trap. To use the trap, fluid is introduced to the fluid chamber through the opening in the gas chamber, to a predetermined level, and the lid is closed. Then the carbon dioxide outlet 25 of the carbon dioxide generator 20 is inserted into the receptacle 16 of the bed bug trap 21. The cross-sectional shape of the outlet 25 is matches the receptacle 16, so that there is little or no carbon dioxide leakage at the connection area. To be well secured to the receptacle 16, the outlet 25 could be a rigid rectangular shape as shown, and can extend into the center of the trap 21. Also, as shown in FIG. 8, the height of the outlet at the bottom of the generator 20 is the same as the height of receptacle 16 of the trap, so they can be mounted together to be used at same location.

As discussed before, in the generator, preferably there is a sponge on the top of the storage chamber, and a chemical lure may be carried on the sponge.

After liquid is added to the generator, liquid passes down to the storage chamber and contacts the solid in the storage chamber, producing carbon dioxide. When the carbon dioxide goes up and passes through the sponge, the chemical lure on the sponge is carried out by the carbon dioxide. Carbon dioxide with the chemical lure directly enters the center of the trap through the outlet 25. It diffuses with the surrounding air, increasing the carbon dioxide levels, with a well defined point of origin. It is through the increased levels of carbon dioxide that the bugs are attracted to the trap seek the origin of the carbon dioxide.

To attract bed bugs to the trap 21, an optional heat pad 17 can also used. As shown in FIG. 6, a heat-generating pad 17 can be attached to the trap by a clip 15. It works as a heat lure for attracting bed bugs to the trap. The generator can also be used for other kinds of insect traps, such as mosquito traps.

It will be evident to those knowledgeable in the field of the invention that many variations on the examples described above are conceivable within the scope of the invention. It should therefore be understood that the claims which define the invention are not restricted to the specific examples described above. Possible variations include, for example, the shape of the cell or the storage chamber.

Further variations may be apparent or become apparent to those knowledgeable in the field of the invention, within the scope of the invention as defined by the claims which follow.

1. A carbon dioxide generator comprising: at least one storage chamber at the bottom, charged with solid that can produce carbon dioxide; a fluid-fillable fluid chamber above the storage chamber; a fluid inlet and a carbon dioxide outlet on the top of the liquid chamber; and one or more fluid entry holes between the fluid chamber and storage chamber for fluid to reach the solid to produce carbon dioxide.

2. A carbon dioxide generator as in claim 1, wherein a gas chamber is positioned above the fluid chamber; and the fluid inlet and the carbon dioxide outlet are on the top of the gas chamber.

3. A carbon dioxide generator as in claims 1, where the storage chamber is divided into two or more cells.

4. A carbon dioxide generator as in claim 3, where a piece of sponge is used in at least one cell.

5. A carbon dioxide generator as in claim 4, where sponge is used in at least two cells, and different cells have different sponge thicknesses and porosity.

6. A carbon dioxide generator as in claim 5, where chemical lure is absorbed on the sponge that can be carried out by produced carbon dioxide.

7. A carbon dioxide generator as in claim 4, where the size or number of fluid entry holes differs between cells.

8. A carbon dioxide generator as in claim 1, where a piece of sponge covers the top of the storage chamber.

9. A carbon dioxide generator as in claim 8, where chemical lure is absorbed on the sponge that can be carried out by produced carbon dioxide.

10. A carbon dioxide generator as in claim 9, where the storage chamber is detachably connected to the fluid chamber.

11. A carbon dioxide generator as in claim 10, where the storage chamber can be replaced by a new storage chamber or be refilled with solid.

12. A carbon dioxide generator as in claim 3, where the storage chamber includes a separate plate with one or more discharge outlets to form a drained space at the bottom of the storage chamber.

13. A method of producing carbon dioxide with a carbon dioxide generator as in claim 1, including adding fluid to the carbon dioxide generator, fluid passing down to the storage chamber, and reacting with the solid in the storage chamber, so that carbon dioxide is released.

14. A method of producing carbon dioxide as in claim 13, wherein sponge is included on the top of the storage chamber.

15. A usage of the carbon dioxide generator as in claim 1, wherein produced carbon dioxide is for traps or detection of crawling insects or flying insects that attracted to carbon dioxide.

16. A usage as in claim 15, wherein the carbon dioxide outlet of the generator inserts to a bed bug trap or mosquito trap.

17. A usage as in claim 16, wherein the storage chamber is divided into two or more cells, the size or number of fluid entry holes to each cells differs between cells, and a piece of sponge is used in at least one cell.

18. A usage as in claim 17, where sponge is used in at least two cells, and different cells have different sponge thicknesses or porosity.

19. A usage as in claim 18, where a drained space is included at the bottom of the storage chamber.

20. A usage as in claim 18, where chemical lure is absorbed on the sponge that can be carried out by produced carbon dioxide.
